(19) United States
(12) Patent Application Publication
(10) Pub. No.: US 2025/0033505 A1
(43) Pub. Date: Jan. 30, 2025

(54) ELECTRIC MICROMOBILITY VEHICLE CHARGING SYSTEMS

(71) Applicant: re:Charge-e, Inc., Albany, NY (US)

(72) Inventors: Julien Claude BOUGET, Albany, NY (US); Erika Suzanne HAACK, Bellevue, WA (US); James Arthur YOUNG, IV, Snohomish, WA (US); Scotty Campbell PATON, Renton, WA (US)

(73) Assignee: re:Charge-e, Inc., Albany, NY (US)

(21) Appl. No.: 18/670,916

(22) Filed: May 22, 2024

Related U.S. Application Data
(60) Provisional application No. 63/515,905, filed on Jul. 27, 2023.

(51) Int. Cl. B60L 53/39; B60L 53/126; B60L 53/30

(52) U.S. Cl. CPC B60L 53/39; B60L 53/126; B60L 53/305; B60L 2200/12; B60L 2200/24

(57) ABSTRACT

Electric micromobility vehicle charging systems are provided which include a docking station, a wireless power receiver device and a wireless power transmitter device. The docking station is configured to facilitate docking of an electric micromobility vehicle with the docking station for charging, and the wireless power receiver device is associated with the electric micromobility vehicle. The wireless power receiver device includes a wireless magnetic resonant receiver. The wireless power transmitter device is associated with the docking station, and includes a wireless magnetic resonant transmitter. The docking station is configured to facilitate operative positioning, at least in part, of the wireless magnetic resonant receiver relative to the wireless magnetic resonant transmitter with docking of the electric micromobility vehicle with the docking station for charging.

### STATEMENT REGARDING GOVERNMENT RIGHTS

Certain aspects of this invention were made with Government support under the New York Energy Research and Development Authority (NYSERDA) Agreement No. 38992A, and with the assistance of the Research Foundation for the State University of New York (SUNY) at Albany (Grantor), in accordance with “Shovel Ready Grant Funding”. Accordingly, the Government may have certain rights in this invention.

### BACKGROUND

This disclosure relates generally to the field of electric micromobility vehicles, and more particularly, to electric micromobility vehicle charging systems.

Micromobility or micromobility vehicles refer to transportation vehicles that are lightweight vehicles, such as bicycles or scooters. As the use of micromobility vehicles expands and becomes increasingly electrified, challenges have arisen in powering the vehicles, and particularly, with powering shared electric micromobility vehicles. In a shared use system, electrified fleets of vehicles frequently require battery charging, which is often a service performed by large teams of technicians using service vehicles to swap batteries at the vehicle's location. This can be a costly process however, that also generates additional greenhouse gas emissions and traffic congestion, which are two issues micromobility vehicles are designed to address.

### SUMMARY

Certain shortcomings of the prior art are overcome, and additional advantages are provided herein through the provision, in one aspect, of an electric micromobility vehicle charging system, which includes a docking station configured to facilitate docking of an electric micromobility vehicle with the docking station for charging. In addition, the electric micromobility vehicle charging system includes a wireless power receiver device associated with the electric micromobility vehicle, and a wireless power transmitter device associated with the docking station. The wireless power receiver device includes a wireless magnetic resonant receiver, and the wireless power transmitter device includes a wireless magnetic resonant transmitter. The docking station is configured to facilitate operative positioning, at least in part, of the wireless magnetic resonant receiver relative to the wireless magnetic resonant transmitter with docking of the electric micromobility vehicle with the docking station for charging.

In another aspect, an electric micromobility vehicle charging system is provided which includes a universal docking station, a wireless power receiver device, and a wireless power transmitter device. The universal docking station includes a wheel guide configured to receive a wheel of an electric micromobility vehicle to facilitate docking of the electric micromobility vehicle with the universal docking station for charging, where the electric micromobility vehicle is one electric micromobility vehicle type of multiple electric micromobility vehicle types dockable for charging within the universal docking station. The wireless power receiver device is associated with the electric micromobility vehicle, and includes a wireless magnetic resonant receiver, and the wireless power transmitter device is associated with the universal docking station, and includes a wireless magnetic resonant transmitter. The universal docking station is configured to facilitate operative positioning, at least in part, of the wireless magnetic resonant receiver associated with the electric micromobility vehicle relative to the wireless magnetic resonant transmitter associated with universal docking station with docking of the electric micromobility vehicle within the universal docking station for charging.

In a further aspect, an electric micromobility vehicle docking station is provided which includes a housing with a wheel-receiving opening within the housing. The wheel-receiving opening is sized to receive a wheel of an electric micromobility vehicle when the electric micromobility vehicle is docked with the electric micromobility vehicle docking station for charging. In addition, the electric micromobility vehicle docking station includes a wireless power transmitter device disposed, at least in part, within the housing over the wheel-receiving opening of the housing. The wireless power transmitter device facilitates wireless power transfer to a wireless power receiver device associated with the electric micromobility vehicle when the electric micromobility vehicle is operatively docked with the electric micromobility vehicle docking station for charging.

Computer-implemented methods, computer program products and computer systems relating to one or more system aspects are also described and claimed herein. Further, services relating to one or more system aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIGS. 1A-1E depicts one embodiment of a wireless power receiver device, of an electric micromobility vehicle charging system, for mounting to an electric micromobility vehicle, in accordance with one or more aspects of the present disclosure;

FIG. 2A depicts one embodiment of a wireless power receiver device of an electric micromobility vehicle charging system, such as the wireless power receiver device of FIGS. 1A-1E, mounted to an electric micromobility vehicle, illustrated, by way of example only, as an electric bike, in accordance with one or more aspects of the present disclosure;

FIG. 2B is an elevational view of the electric micromobility vehicle and wireless power receiver device of FIG. 2A docked within a docking station of an electric micromobility vehicle charging system for charging, in accordance with one or more aspects of the present disclosure;

FIG. 2C is an enlarged cross-sectional view of the wireless power receiver device and docking station of FIG. 2B, illustrating charging position of the wireless magnetic resonant receiver relative to a wireless magnetic resonant transmitter, in accordance with one or more aspects of the present disclosure;

FIG. 3 depicts the docked electric micromobility vehicle and docking station of FIGS. 2B-2C, with the wireless magnetic resonant receiver in charging position relative to the wireless magnetic resonant transmitter of the docking station, in accordance with one or more aspects of the present disclosure;

FIG. 4A-4D depicts another embodiment of a wireless power receiver device of an electric micromobility vehicle charging system for mounting to an electric micromobility vehicle, in accordance with one or more aspects of the present disclosure;

FIG. 5A depicts a further embodiment of a wireless power receiver device of an electric micromobility vehicle charging system, such as the wireless power receiver device of FIGS. 4A-4D, mounted to an electric micromobility vehicle illustrated, by way of example, as an electric scooter, in accordance with one or more aspects of the present disclosure;

FIG. 5B is an enlarged, partial elevational view of the wireless power receiver device of FIG. 5A, shown mounted to the column of the electric micromobility vehicle, in accordance with one or more aspects of the present disclosure;

FIG. 5C is a partial cross-sectional view of the wireless power receiver device and electric micromobility vehicle of FIGS. 5A-5B docked within a docking station of an electric micromobility vehicle charging system, with the wireless magnetic resonant receiver in charging position relative to the wireless magnetic resonant transmitter, in accordance with one or more aspects of the present disclosure;

FIG. 6A depicts one embodiment of a docking station of an electric micromobility vehicle charging system, in accordance with one or more aspects of the present disclosure;

FIG. 6B illustrates one embodiment of a wireless power transmitter device of an electric micromobility vehicle charging system, shown positioned within the docking station of FIG. 6A, in accordance with one or more aspects of the present disclosure;

FIG. 7 depicts one embodiment of a docking station subsystem of an electric micromobility vehicle charging system, with the docking station subsystem shown as including multiple docking stations, such as multiple ones of the docking station of FIGS. 6A-6B, in accordance with one or more aspects of the present disclosure;

FIG. 8 is a schematic of further details of one embodiment of a docking station subsystem of an electric micromobility vehicle charging system, in accordance with one or more aspects of the present disclosure;

FIG. 9 depicts one embodiment of a computing environment for an electric micromobility vehicle charging system, in accordance with one or more aspects of the present disclosure; and

FIG. 10 depicts one embodiment of a computer system of a computing environment for an electric micromobility vehicle charging system, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative system embodiments are described below, in part, using specific designs, architectures, protocols, layouts, schematics, or systems only as examples, and not by way of limitation. Furthermore, the illustrative system embodiments are described in certain instances using particular data processing environments as example for clarity of description. The illustrative embodiments can be used in conjunction with other comparable or similarly purposed structures, systems, applications, architectures, etc. Also note that one or more aspects of an illustrative control system embodiment can be implemented in software, hardware, or a combination thereof.

As noted, micromobility vehicles are lightweight personal transportation vehicles, such as bicycles or scooters. As these vehicles are increasingly becoming electrified, challenges have arisen in powering the vehicles, and particularly in powering shared electric micromobility vehicles. In a shared use system, electrified fleets of vehicles frequently require battery charging, which is often a service performed by teams of technicians using service vehicles to swap batteries at the vehicle's location. This can be a costly process, that also generates additional greenhouse gas emissions and traffic congestion, which are two issues micromobility vehicles are designed to address.

Another approach to charging multiple types of shared electric micromobility vehicles is to provide charging stations equipped with several different types of cables at each station to handle different types of electric micromobility vehicles. In use, when a user parks an electric micromobility vehicle for charging, the user is required to identify the cable which fits the particular electric micromobility vehicle input port, and has to plug the cable properly to allow charging to occur. Note that this approach is also subject to dust and water ingress on the contacts, which can lead to poor performance and/or malfunction over time. Further, cables can become damaged, and the range of the direct current voltage that can be supplied is limited. In addition, the amount of energy delivered to the individual vehicle's battery may not be tracked or recorded.

In a further approach, a charging station can be deployed which is equipped with contact-based power transfer, without the use of cables. In such a contact-based power transfer approach, the range of direct current that can be provided is again limited. This solution is also subject to dust and water ingress, which can lead to malfunction of the system over time. Further, the physical contacts are subject to wear and tear, which can ultimately lead to power transfer performance degradation and/or malfunction.

Addressing these issues, disclosed herein are electric micromobility vehicle charging systems which embody a universal wireless charging solution for multiple different types of electric micromobility vehicles, such as multiple different shared electric micromobility vehicles. In one or more aspects, electric micromobility vehicle charging systems are provided which include a docking station, a wireless power receiver device, and a wireless power transmitter device. The docking station is configured to facilitate docking of an electric micromobility vehicle with the docking station for charging, with the wireless power receiver device being associated with the electric micromobility vehicle and the wireless power transmitter device being associated with the docking station. The wireless power receiver device includes, for instance, a wireless magnetic resonant receiver, and the wireless power transmitter device includes a wireless magnetic resonant transmitter. The docking station is configured to facilitate operative positioning, at least in part, of the wireless magnetic resonant receiver relative to the wireless magnetic resonant transmitter with docking of the electric micromobility vehicle with the docking station for charging. The operative positioning is to establish a resonant inductive coupling between the transmitter and the receiver.

In one or more embodiments, the wireless magnetic resonant transmitter includes a transmitter coil and the wireless magnetic resonant receiver includes a receiver coil, and the docking station is configured to facilitate operative positioning of the receiver coil relative to the transmitter coil with docking of the electric micromobility vehicle with the docking station for charging. In one embodiment, with operative positioning of the receiver coil relative to the transmitter coil, the receiver coil and the transmitter coil are substantially parallel, and in one or more implementations, one coil at least partially overlies the other coil.

In one or more embodiments, the transmitter is located in an upper portion of the docking station, and the docking station further includes a cover over the transmitter coil in the upper portion of the docking station.

In one or more embodiments of the electric micromobility vehicle charging system, the cover includes an alignment feature to facilitate guiding, at least in part, the receiver coil into charging position relative to the transmitter coil with docking of the electric micromobility vehicle with the docking station for charging. In one or more implementations, the alignment feature of the cover is configured to be engaged by another alignment feature of a receiver coil housing, containing the receiver coil, to facilitate operative positioning of the receiver coil relative to the transmitter coil with docking of the electric micromobility vehicle with a docking station for charging.

In one or more embodiments, the alignment feature of the cover includes a triangular-shaped receiving channel formed in the cover, and the other alignment feature includes a triangular-shaped alignment element sized and configured to reside within the triangular-shaped receiving channel in the cover of the docking station with docking of the electric micromobility vehicle with the docking station for charging.

In one or more embodiments, the cover further includes an interlock element associated with the alignment feature. The interlock element is configured to engage with another interlock element associated with the other alignment feature of the receiver coil housing with docking of the electric micromobility vehicle with the docking station for charging.

In one embodiment, the alignment feature includes a receiving channel formed in the cover and the interlock element includes at least one knob within the receiving channel formed in the cover of the docking station.

In one or more embodiments, the docking station includes a wheel guide configured to receive a wheel of the electric micromobility vehicle with docking of the electric micromobility vehicle with the docking station for charging, and a vertically extending housing angled in a direction of docking of the electric micromobility vehicle with the docking station.

In another aspect, an electric micromobility vehicle charging system is provided which includes a universal docking station, a wireless power receiver device, and a wireless power transmitter device. The universal docking station includes a wheel guide configured to receive a wheel of an electric micromobility vehicle to facilitate docking of the electric micromobility vehicle with the universal docking station for charging. The electric micromobility vehicle is one electric micromobility vehicle type of multiple electric micromobility vehicle types dockable for charging within the universal docking station. The wireless power receiver device is associated with the electric micromobility vehicle, and includes a wireless magnetic resonant receiver. The wireless power transmitter device is associated with the docking station, and includes a wireless magnetic resonant transmitter. The docking station is configured to facilitate operative positioning, at least in part, of the wireless magnetic resonant receiver associated with the electric micromobility vehicle relative to the wireless magnetic resonant transmitter associated with the docking station with docking of the electric micromobility vehicle within the universal docking station for charging.

In one embodiment of the micromobility vehicle charging system, the multiple electric micromobility vehicle types are selected from the group consisting of electric bike types and electric scooter types. In one or more embodiments, at least two electric micromobility vehicle types of the multiple micromobility vehicle types have different battery types associated therewith to respectively power the at least two electric micromobility vehicle types.

In an embodiment of the electric micromobility vehicle charging system, the wireless magnetic resonant transmitter includes a transmitter coil and the wireless magnetic resonant receiver includes a receiver coil, and with universal docking station is configured to facilitate operative positioning of the receiver coil relative to the transmitter coil with operative docking of the electric micromobility vehicle with the universal docking station for charging.

In one or more embodiments, the transmitter coil is located in an upper portion of the universal docking station, and the electric micromobility vehicle charging system further includes a cover over the transmitter coil in the upper portion of the universal docking station. The cover includes an alignment feature to facilitate guiding, at least in part, the receiver coil into a charging position relative to the transmitter coil with docking of the electric micromobility vehicle within the universal docking station for charging.

In one or more embodiments of the electric micromobility vehicle charging system, the alignment feature of the cover is configured to be engaged by another alignment feature of a receiver coil housing containing the receiver coil to facilitate operative positioning of the receiver coil relative to the transmitter coil with docking of the electric micromobility vehicle with the universal docking station for charging.

In one or more embodiments of the electric micromobility vehicle charging system, the cover further includes an interlock element associated with the alignment feature. The interlock element is configured to engage with another interlock element associated with the other alignment feature of the receiver coil housing with docking of the electric micromobility vehicle with the universal docking station for charging.

In another aspect, an electric micromobility vehicle docking station of an electric micromobility vehicle charging system is provided. The electric micromobility vehicle docking station includes a housing, and a wireless power transmitter device. The housing has a wheel-receiving opening within the housing, with the wheel-receiving opening being sized to receive a wheel of an electric micromobility vehicle when the electric micromobility vehicle is docked with the electric micromobility vehicle docking station for charging. The wireless power transmitter device is disposed, at least in part, within the housing over the wheel-receiving opening of the housing. The wireless power transmitter device facilitates wireless power transfer to a wireless power receiver device associated with the electric micromobility vehicle when the electric micromobility vehicle is operatively docked with the electric micromobility vehicle docking station for charging.

In one or more embodiments of the electric micromobility vehicle docking station, the wireless power transmitter device includes a wireless magnetic resonant transmitter, and the wireless power receiver device includes a wireless magnetic resonant receiver, and the wireless magnetic resonant transmitter is position within the housing over the wheel-receiving opening of the housing.

In one or more embodiments of the electric micromobility vehicle docking station, the wheel-receiving opening extends through the housing.

As noted, in one or more aspects, the electric micromobility vehicle charging systems disclosed herein embody a universal wireless charging solution designed as a shared resource for multiple different types of electric micromobility vehicles, and for the electric micromobility industry in general. In one or more aspects, using magnetic resonant wireless power transfer, and an intelligent power control, the systems disclosed can be used with a variety of micromobility vehicle types, and a range of associated battery types, thereby insuring that one or more shared electric micromobility vehicle operators can use the electric micromobility vehicle charging systems disclosed. In one or more embodiments, the electric micromobility vehicle charging systems are designed to enhance shared electric micromobility, and to facilitate enhancing sustainability of electric micromobility. The systems disclosed herein embody, or include, a physical infrastructure, and an information technology (IT) infrastructure and associated control code or software dedicated, in one or more embodiments, to universal charging of multiple different types of electric bikes, electric scooters, etc. In one or more embodiments, outdoor-rated physical infrastructure is employed which utilizes magnetic resonant wireless power transfer technology within the infrastructure to provide the charging capabilities for the micromobility vehicles. A charge as a service (CaaS) software approach can be used (in one embodiment) to monetize charging services based on actual energy delivered to vehicle batteries, which as noted, can be third-party owned electric bikes, electric scooters, etc. With this approach, the universal electric micromobility vehicle charging infrastructure disclosed herein relieves shared micromobility system operators from deploying charging infrastructure to charge their electric micromobility vehicles.

Note further that the electric micromobility vehicle charging systems disclosed herein use, in one or more embodiments, magnetic resonant wireless power transfer technology. This contactless solution reduces potential user error with improper use of the charging infrastructure, and also eliminates risks associated with water and dust ingress, as well as potential consequences of contact wear and tear. The remote control operation capabilities disclosed herein, and the associated computing infrastructure, allow an independent developer to maintain oversight of the micromobility vehicle charging systems and to sell charging services based on actual energy delivered to vehicle batteries. Further, in one or more embodiments, the system control aspects disclosed can implement an innovative charging as a service (CaaS) approach based on the application of, for instance, power purchase agreements (PPA) to the micromobility sector. The electric micromobility vehicle charging systems disclosed solve the problem of charging electric bikes, electric scooters, etc. for shared micromobility system operators in a more efficient manner. The systems include devices or equipment to be mounted on the vehicles, such as at the front of the vehicles, as well as docking stations to be deployed at selected geographic locations, with the docking stations being powered by connections, in one embodiment, to the electrical grid, or other power source. Additionally, the systems disclosed herein include an IT infrastructure, and a control process. When an electric micromobility vehicle, such as a vehicle owned by a shared micromobility operator, is equipped with a wireless power receiver device or electronics as disclosed herein, it is capable of receiving power from a docking station (or charging station), such as disclosed.

As an operational example, when an electric micromobility vehicle equipped with a wireless power receiver device such as disclosed herein is operatively docked at a docking station, its presence is detected via, for instance, a wireless communication protocol between the wireless power receiver device and the wireless power transmitter device. In one embodiment, the wireless power receiver device includes electronic equipment, mounted on the vehicle, and the wireless power transmitter device includes electronic equipment, mounted within the docking station, that are configured to communicate when the micromobility vehicle is docked with the docking station. A vehicle specific identification can be checked by the system control as part of a validation procedure against a database of valid vehicle identifications. Assuming that the identification is valid (e.g., the owner of the vehicle is in good standing and a PPA has been executed between the vehicle owner and the charging system owner, etc.), the system control (e.g., remote system control) authorizes magnetic resonant power transfer to the electric micromobility vehicle to be initiated, within the parameters of the charging session being recorded and saved, for instance, in a charging session log. The charging session log can include, for instance, charging session start time and date, docking station ID and location, vehicle identification, battery voltage at charging session initiation, battery voltage level and battery charging current at regular intervals (e.g., every x seconds), and charging session end time and date. In this manner, the vehicle owner, such as a shared micromobility operator, can be charged for the actual energy transferred to their vehicle's battery by the docking station.

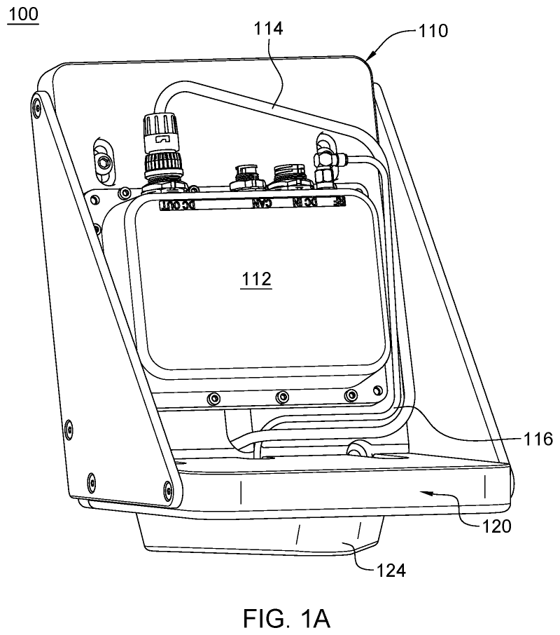

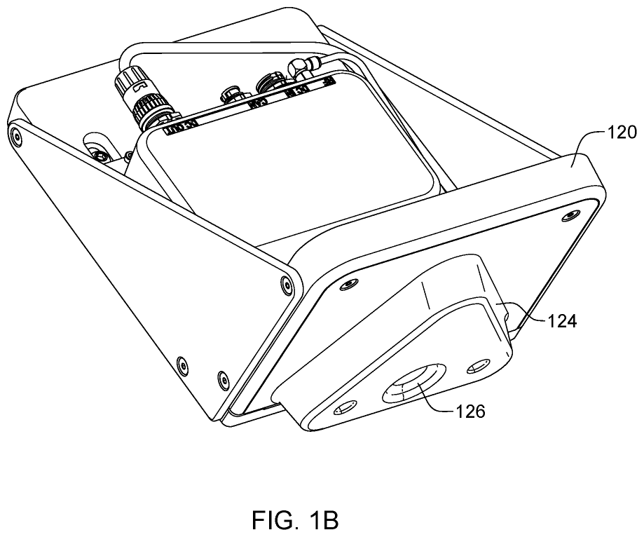

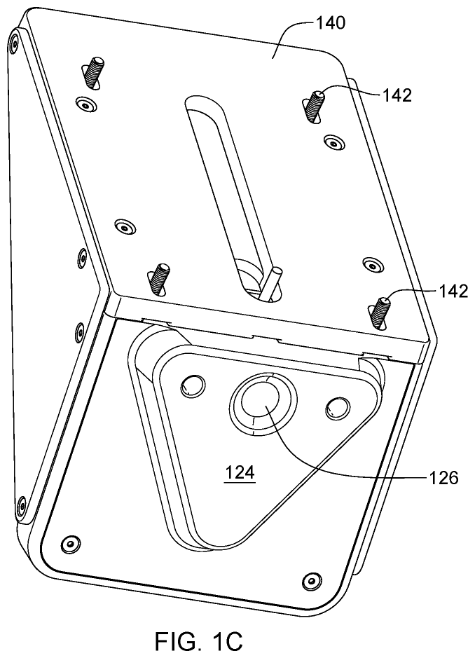

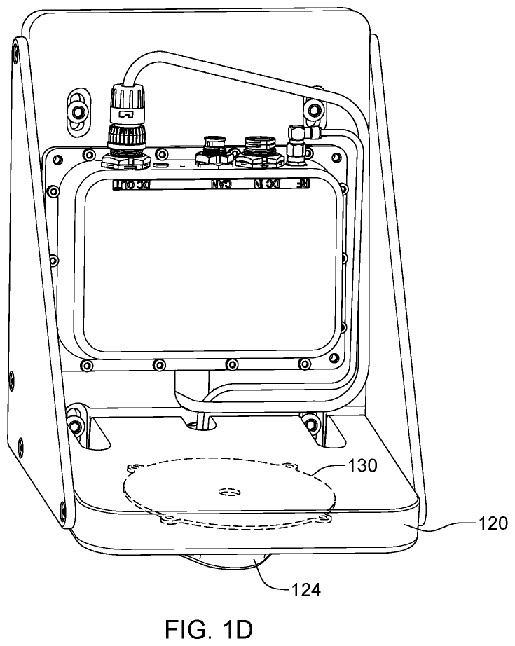

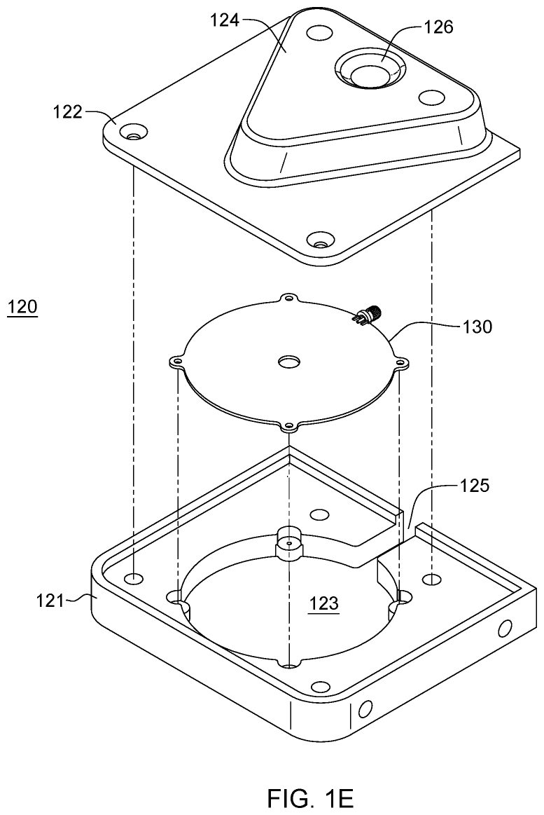

By way of further explanation, electric micromobility charging systems are disclosed herein which include one or more docking stations (i.e., charging stations) configured to facilitate docking of an electric micromobility vehicle with the docking station for charging. The systems include a wireless power receiver device associated with the electric micromobility vehicle, and a wireless transmitter device associated with the docking station. FIGS. 1A-1E depicts one embodiment of a wireless power receiver device, in accordance with one or more aspects of present disclosure.

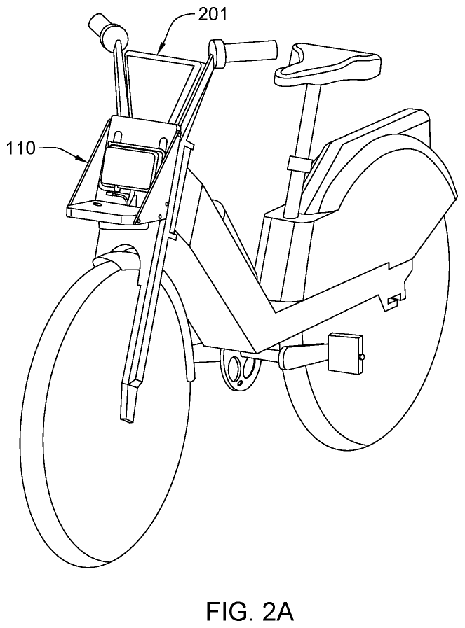

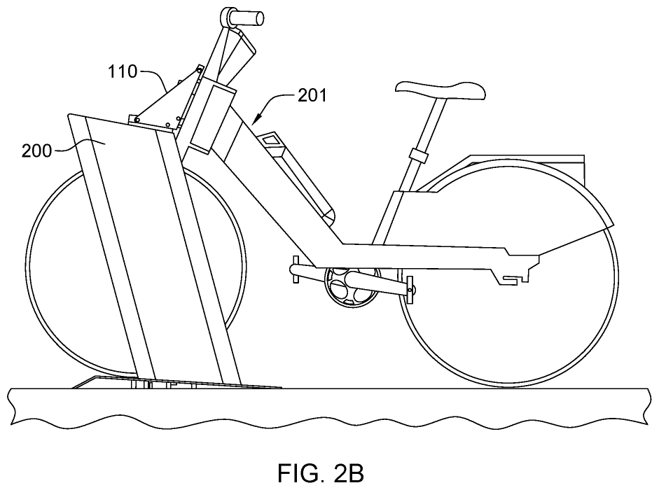

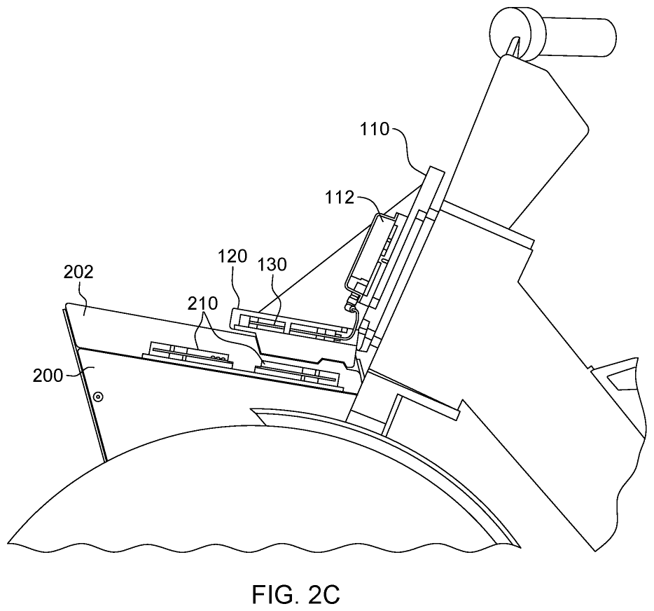

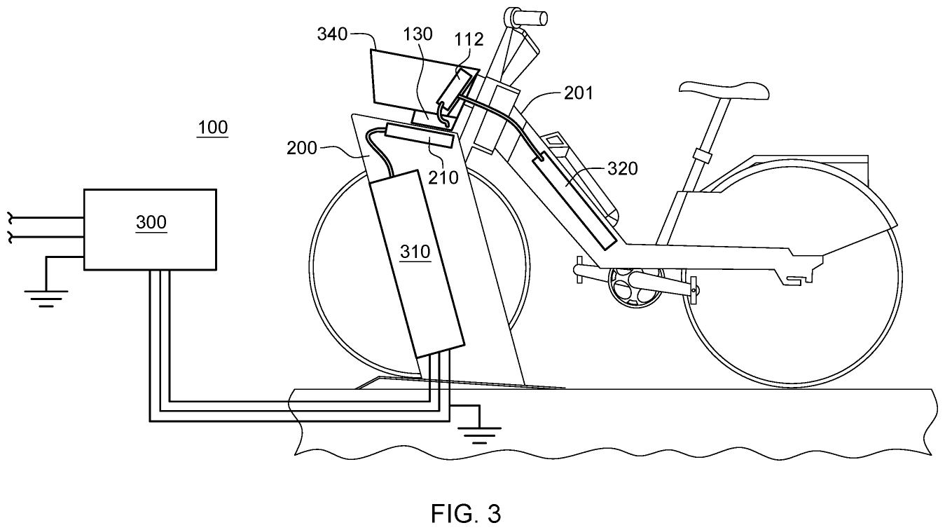

Referring collectively to FIGS. 1A-1E, an outdoor-rated wireless power receiver device 110 is shown as part of an electric micromobility vehicle charging system 100 (illustrated, for instance, in FIGS. 2B-3). In the depicted embodiment, wireless power receiving device 110 includes an onboard direct current (DC) charger 112 to provide DC power to the one or more vehicle batteries for charging the batteries when a charging session has been initiated with the electric micromobility vehicle operatively positioned relative to the docking station for charging. Note that, in one or more embodiments, wireless power receiver device 110 of FIGS. 1A-1E can be part of, reside within, or be configured to support, a vehicle basket, such as a front mounted basket on the electric micromobility vehicle (such as illustrated in FIG. 3, by way of example only). Electric wires 114 are provided to connect the direct current output of DC charger 112 directly to the battery cells, or to a battery management system (BMS), of the electric micromobility vehicle.

In one or more embodiments, the wireless power receiver device also includes a wireless magnetic resonant receiver, which can be positioned within a receiver housing 120 disposed (in one example) at a lower portion of wireless power receiver device 110. In one or more embodiments, the wireless magnetic resonant receiver includes a receiver coil 130 (FIG. 1E) disposed within housing 120, such as between one portion 121 of housing 120 and another portion or cover 122 of housing 120. In one embodiment, the receiver coil 130 can be positioned within an appropriately configured and sized recess 123 in the one portion 121 of housing 120, which can also include a channel 125 to allow electrical connection between receiver coil 130 and DC charger 112, for instance, via a coaxial cable (in one embodiment). Note that although the structures of wireless power receiver device 110 can be formed of a variety of materials, receiver housing 120 is to be formed of a material that does not interfere with wireless magnetic resonant power transfer to the receiver coil from the wireless magnetic resonant transmitter associated with the docking station, such as described herein. For instance, in one embodiment, housing 120 can be a weather-tight plastic housing.

As illustrated in FIGS. 1A-1E, in one embodiment, other portion 122 of receiver housing 120 of wireless power receiver device 110 includes an alignment feature 124 located below the receiver coil 130 within receiver housing 120. Alignment feature 124 can take a variety of forms. In one or more embodiments, a triangular-shaped form (such as illustrated) advantageously facilities proper positioning of the electric micromobility vehicle relative to the docking station for charging, and in particular, facilitates operative positioning, at least in part, of the wireless magnetic resonant receiver of the vehicle relative to the wireless magnetic resonant transmitter of the docking station with docking of the electric micromobility vehicle with the docking station for charging.

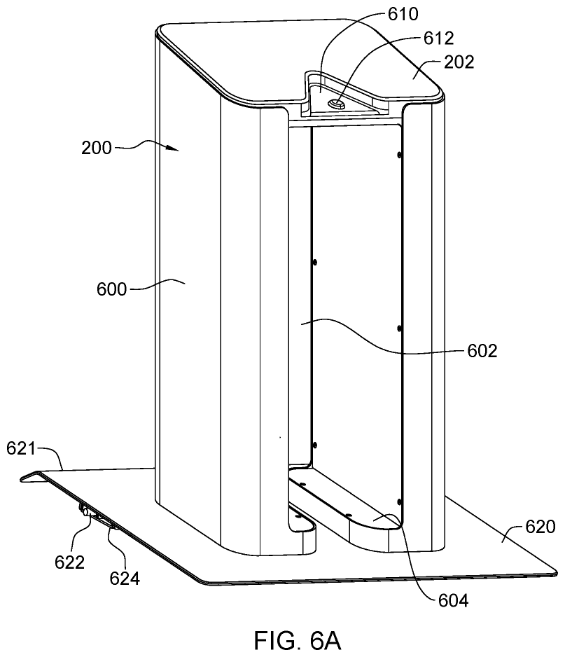

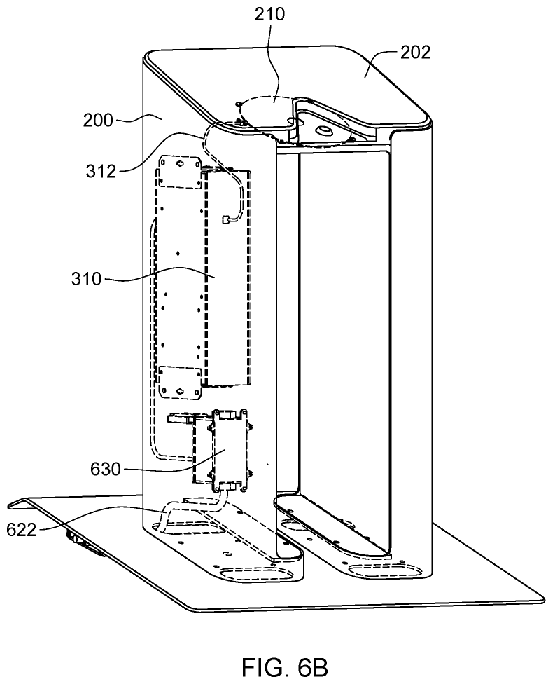

Advantageously, alignment feature 124 also provides added mechanical protection to receiver coil 130 within housing 120. One or more interlock elements 126 can be associated with alignment feature 124 for interlocking or holding the alignment feature in place once docked with the docking station. For instance, in one or more embodiments, the docking station can have another alignment feature configured to accommodate alignment feature 124 of the wireless power receiver device 110. In one embodiment, this alignment feature of the docking station itself can include an interlock element associated with the alignment feature, such as one or more protrusions or knobs within a receiving channel in the cover of the docking station (such as shown in FIG. 6A), where the receiving channel is configured to receive the alignment feature 124 of the wireless power receiver device. In one or more embodiments, each knob is sized and configured to reside within a respective recess, or interlock element 126, associated with alignment feature 124 at the underside of housing 120. Note in this regard that the configuration and placement of the respective interlock elements can vary, depending on the implementation. For instance, in one or more embodiments, the one or more protrusions or knobs can be associated with alignment feature 124 of the wireless power receiver device, and one or more recesses can be associated with the other alignment feature in the cover of the docking station. Other variations are also possible.

In one or more embodiments, wireless power receiver device 110 is mounted to the electric micromobility vehicle, such as to the frame of an electric bike, via a mounting plate 140 provided with appropriate openings for accommodating one or more fasteners 142, such as one or more bolts, to fasten the wireless power receiver device to the frame of the vehicle (see, for instance, FIGS. 2A-3). Note that the size, configuration, and/or geometry of the wireless power receiver device and how the device mounts to the electric vehicle can be modified or adapted for each vehicle's specific geometry. For instance, in one or more other embodiments, the wireless power receiver device can be brazed, soldered, or welded to the vehicle, and/or formed integral with the vehicle. Many variations are possible.

By way of example, FIG. 2A depicts one embodiment of wireless power receiver device 110 mounted to an electric micromobility vehicle 201 represented, in one embodiment, as an electric bike. As illustrated, in one or more implementations, wireless power receiver device 110 can be configured to mount to a forward portion, such as to a front column, of the electric micromobility vehicle 201. Also, as noted herein, wireless power receiver device 110 can be associated with, or part of, a basket mounted at the front of the electric micromobility vehicle, such as illustrated in FIG. 3, by way of example.

In FIG. 2B, electric micromobility vehicle 201 is shown docked in charging position within a docking station 200 (or charging station), of an electric micromobility vehicle charging system, such as disclosed herein. As illustrated in FIG. 2C, docking station 200 includes, in one or more embodiments, a wireless magnetic resonant transmitter 210 of the wireless power transmitter device associated with docking station 200. In one or more implementations, wireless magnetic resonant transmitter 210 is located in an upper portion of docking station 200, such as within a cover 202, that is sealed to protect the wireless power transmitter device from the elements. As illustrated in FIG. 2C, when in operative position for charging, wireless magnetic resonant receiver 130 is spaced from and substantially parallel to wireless magnetic resonant transmitter 210 in the upper portion of docking station 200. In one or more implementations, cover 202 and housing 120 are formed of a plastic material or other material selected to not interfere with wireless power transfer between wireless magnetic resonant transmitter 210 and wireless magnetic resonant receiver 130 when the electric micromobility vehicle batteries are undergoing charging.

FIG. 3 illustrates in greater detail one embodiment of electric micromobility vehicle charging system 100, with electric micromobility vehicle 201 docked within docking station 200 for charging. In this embodiment, docking station 200 is shown electrically connected (such as via, for instance, a junction box or GFCI outlet) to the grid power, such as to a 110V AC metered service connection 300. In one or more embodiments, grid power is supplied to the wireless power transmitter device, and in particular, to a transmitter electronic box 310 within docking station 200 which, in one or more embodiments, takes the 110V AC power in and outputs a high frequency alternating current, such as 6.7 MHz in one example only, to drive the wireless magnetic resonant transmitter 210. The wireless magnetic resonant transmitter 210 wirelessly transmits power to the wireless magnetic resonant receiver 130 of the wireless power receiver device associated with (e.g., coupled, fastened, secured, welded to, etc.) the electric micromobility vehicle 201. Received power is converted by onboard DC charger 112 into a DC current for charging one or more vehicle batteries 320 incorporated within or mounted to electric micromobility vehicle 201. Note that, in this example, electric micromobility vehicle 201 includes an embodiment of a front mounted basket 340 within which, or in association with which, the wireless power receiver device is positioned. In this manner, one or more electronic components of the wireless power receiver device are further protected by the structure of basket 340.

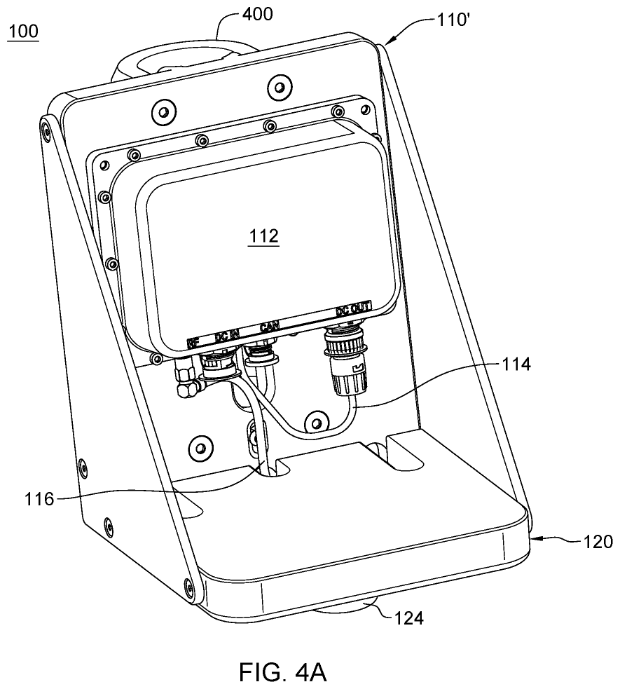

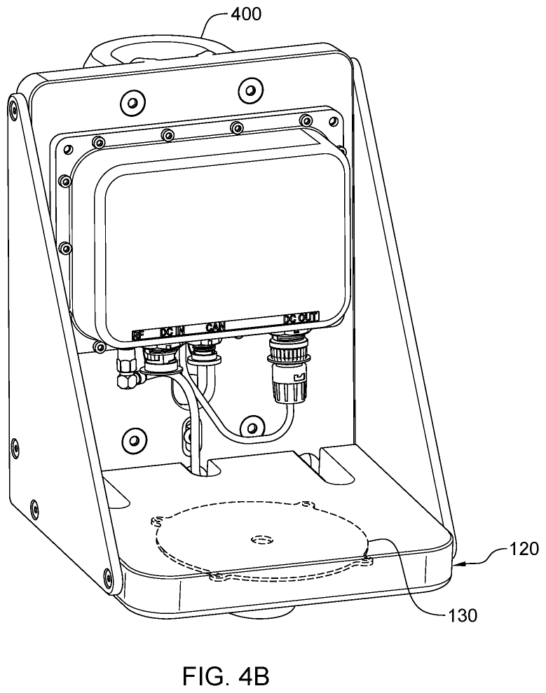

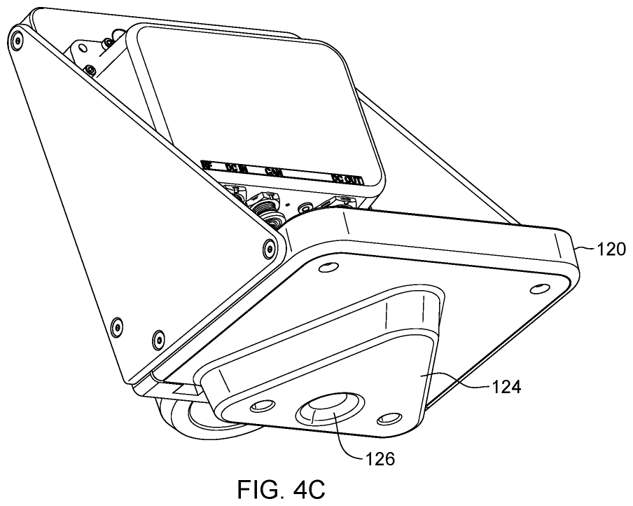

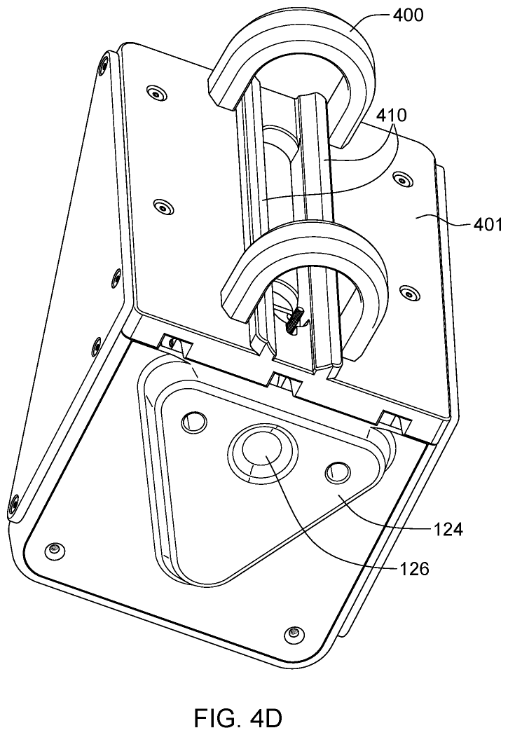

As a further example, FIGS. 4A-4D depict another embodiment of a wireless power receiver device 110′, in accordance with one or more aspects of present disclosure. Wireless power receiver device 110′ is shown to include the same or similar electronics as wireless power receiver device 110 of FIGS. 1A-3. In the embodiment of FIGS. 4A-4D, one or more of the electronic components (such as DC charger 112) are repositioned, for instance, to facilitate mounting of the wireless power receiver device 110′ to the electric micromobility vehicle, such as to the column of an electric scooter, as one example only.

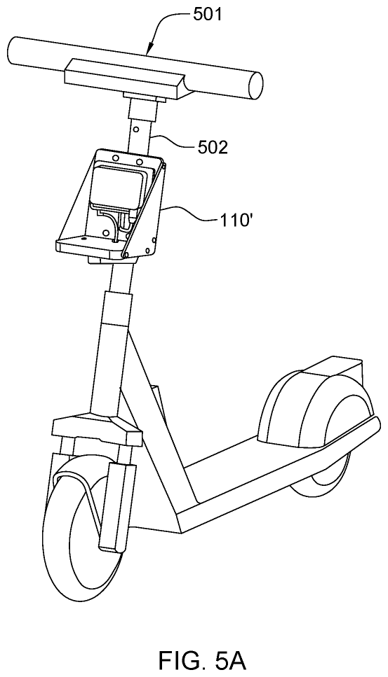

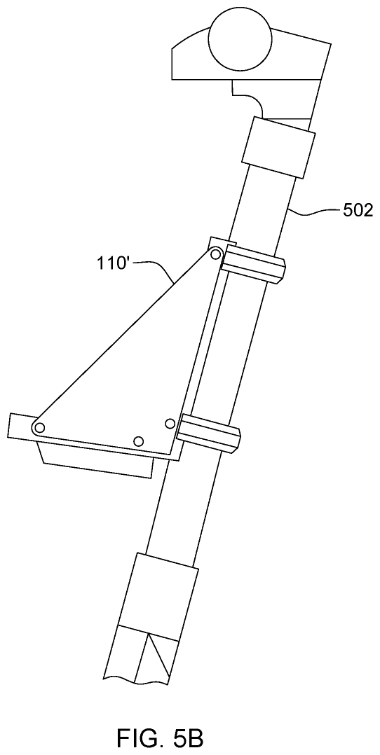

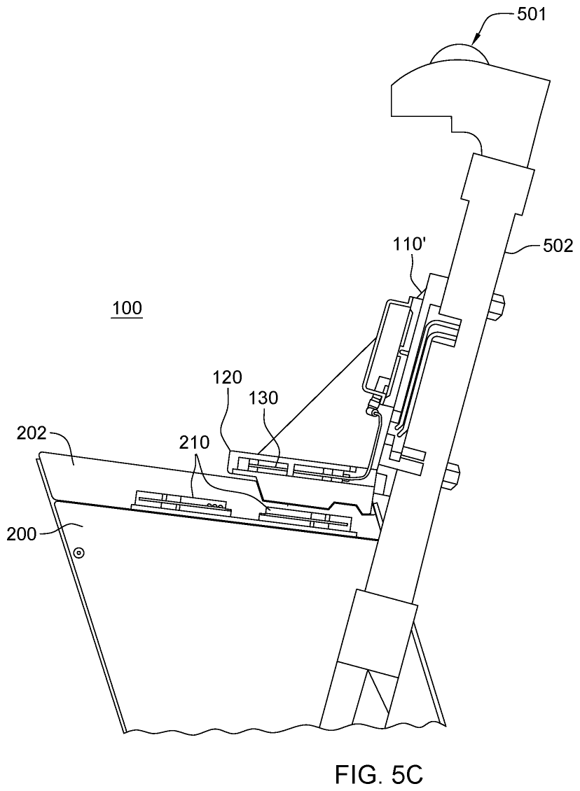

Referring collectively to FIGS. 4A-4D, wireless power receiver device 110′ is shown as part of the electric micromobility vehicle charging system 100 (such as illustrated, for instance, in FIG. 5C). As shown, wireless power receiver device 110′ includes onboard DC charger 112 to provide DC power to one or more vehicle batteries for charging the batteries when the electric micromobility vehicle is operatively positioned relative to the docking station for charging. Note that, in one or more embodiments, wireless power receiver device 110′ of FIGS. 4A-4D can be part of, reside within, be configured to support, etc., a vehicle basket (not shown), such as a front mounted basket on a column of the electric micromobility vehicle. One or more electric wires 114 are provided to connect the direct current output of onboard DC charger 112 to the battery cells, or to a battery management system (BMS) of the electric micromobility vehicle.

As with the embodiment of FIGS. 1A-1E, wireless power receiver device 110′ also includes a wireless magnetic resonant receiver, which is positioned within a receiver housing 120 disposed at a lower portion of wireless power receiver device 110′. For instance, in one or more embodiments, the wireless magnetic resonant receiver includes a receiver coil 130 (FIG. 4B) disposed within housing 120, such as in a similar manner to that described above in connection with FIG. 1E.

As illustrated in FIGS. 4A-4D, the lower portion of housing 120 includes, in one or more embodiments, an alignment feature 124 that is located below receiver coil 130 within receiver housing 120. Alignment feature 124 can take a variety of forms. In one or more embodiments, a triangular-shaped form such as illustrated advantageously facilitates proper positioning of the electric micromobility vehicle relative to the docking station for charging, and in particular, facilitates operative positioning, at least in part, of the wireless magnetic resonant receiver of the vehicle relative to the wireless magnetic resonant transmitter of the docking station with docking of the electric micromobility vehicle with the docking station for charging.

As noted above, alignment feature 124 also advantageously provides added mechanical protection to receiver coil 130 within housing 120. One or more interlock elements 126 can be provided in association with alignment feature 124 for interlocking or holding the alignment feature in place once docked within the docking station. For instance, in one or more embodiments, the docking station can have another alignment feature configured to accommodate alignment feature 124 of wireless power receiver device 110′. In one embodiment, this alignment feature of the docking station can itself include an interlock element associated with the alignment feature, such as one or more protrusions or knobs within a receiving channel in the cover of the docking station, where the receiving channel is configured to receive the alignment feature 124 of the wireless power receiver device. In one or more embodiments, each knob is sized and configured to reside within a respective recess or interlock element 126 associated with alignment feature 124 at the underside of housing 120. Note in this regard that the configuration and placement of the respective interlock elements can vary, depending on the implementation. For instance, in one or more embodiments, the one or more protrusions or knobs can be associated with alignment feature 124 of the wireless power receiver device, and one or more recesses can be associated with the other alignment feature in the cover of the docking station. Other variations are also possible.

As illustrated in FIGS. 4A-4D, wireless power receiver device 110′ can be mounted to the electric micromobility vehicle via a mounting plate 401 which includes one or more U-shaped brackets 400 and column engaging or receiving rails 410 which together facilitate mounting the wireless power receiver device 110′ to a column of the electric micromobility vehicle, such as to the column of an electric scooter, such as illustrated by way of example in FIGS. 5A-5C. Note that in one or more embodiments, one or more bolts or other fasteners can be used to adjustably secure brackets 400 about the column of the electric micromobility vehicle. As noted with respect to FIGS. 1A-1E, the size, configuration, and/or geometry of wireless power receiver device 110′, and how the device mounts to the electric vehicle, can be modified or adapted for each vehicle's specific geometry.

By way of example, FIGS. 5A-5C depict one embodiment of wireless power receiver device 110′ mounted to an electric micromobility vehicle 501 represented, as an example, as an electric scooter. As illustrated in FIGS. 5A-5B, in one or more implementations, wireless power receiver device 110′ can be configured to mount to a forward portion, such as to a front column 502 of electric micromobility vehicle 501. Also, in one or more embodiments, wireless power receiver device 110′ can be associated with, or part of, a basket (not shown) mounted to the front of the electric micromobility vehicle. FIG. 5C depicts electric micromobility vehicle 501 docked in charging position within a docking station 200 of an electric micromobility vehicle charging system 100, such as disclosed herein. As described above in connection with FIG. 2C, docking station 200 includes, in one or more embodiments, a wireless magnetic resonant transmitter 210 of the wireless power transmitter device associated with docking station 200. In one or more implementations, wireless magnetic resonant transmitter 210 is located in an upper portion of docking station 200 within a cover 202, such as a cover sealed to protect the wireless power transmitter from the elements. When in operative position for charging as illustrated in FIG. 5C, wireless magnetic resonant receiver 130 is spaced from and substantially parallel to wireless magnetic resonant transmitter 210 in the upper portion of docking station 200. In one or more implementations, cover 202 and housing 120 are formed of a plastic material or other material selected so as to not interfere with wireless magnetic resonant power transfer between wireless magnetic resonant transmitter 210 and wireless magnetic resonant receiver 130 when the electric micromobility vehicle is undergoing charging.

FIGS. 6A-6B illustrate one embodiment of docking station 200, also referred to herein as the universal docking station or charging station. Docking station 200 includes a housing 600 with a wheel-receiving opening 602 sized and configured to receive a wheel of an electric micromobility vehicle to facilitate docking of the electric micromobility vehicle with the docking station for charging. In one or more embodiments, opening 602 can extend through housing 600, such as through a center of housing 600. As illustrated, a wheel guide 604 can be provided, in one or more embodiments, to facilitate directing the wheel of the electric micromobility vehicle into the docking station opening. In one or more implementations, wheel guide 604 can be configured to accommodate vehicle wheels of various sizes. In one or more embodiments, docking station 200 is an outdoor-rated charging station which can be, for instance, grid connected or otherwise powered, such as via solar power. In one embodiment, housing 600 provides a substantially weather-tight seal to protect the electronic components within the housing.

In one or more embodiments, docking station 200 mounts to a base plate 620, such as a metal base plate with an angled portion 621 to accommodate one or more channels 624 underneath the base plate to physically protect one or more electrical and ethernet cables 622 that run under the charging station and connect the charging station to the power source, such as an electrical grid, or other power source. As illustrated in FIG. 3, the housing of docking station 200 is, in one or more embodiments, a vertically extending structure that leans forward in a direction of docking of the electric micromobility vehicle. With this configuration, the user intuitively positions the vehicle by first centering the vehicle's front wheel within the opening using wheel guide 604, and continues with the process of pushing the vehicle's wireless power receiver device over cover 202 of docking station 200 using the alignment features of the receiver housing and cover 202 as a guide. As illustrated in FIGS. 6A-6B, cover 202 can be configured with a receiving channel 610 provided as an alignment feature. In one embodiment, the alignment feature 610 is a triangular-shaped receiving channel sized and configured to engage the alignment feature of the wireless power receiver device with docking of the electric micromobility vehicle within a docking station. One or more interlock features 612, such as one or more protrusions or knobs within the receiving channel can also be provided to facilitate holding the wireless magnetic resonant receiver in charging position relative to the wireless magnetic resonant transmitter once docked for charging.

As illustrated in FIG. 6B, in one embodiment, an electric cable 622 provides power via a ground fault circuit interrupter (GFCI) 630 to the wireless power transmitter device, which can include a transmitter electronic box 310 and a wireless magnetic resonant transmitter, such as a transmitter coil 210, as described herein. In one or more embodiments, a coaxial cable 312 electrically connects transmitter electronics 310 to transmitter coil 210. In one embodiment, transmitter coil 210 is disposed in an upper portion of docking station 200 over wheel-receiving opening 602 (FIG. 6A) and within, or below, cover 202. As noted, cover 202 can be a plastic cover designed to protect docking station 200 from water and dust ingress, as well provide added mechanical and/or structural protection to transmitter coil 210 with repeated docking and undocking of electric micromobility vehicles for charging. As noted, the provision of triangular-shaped receiving channel 610 (FIG. 6A) in the upper portion of docking station 200 facilitates a user aligning the vehicle's wireless magnetic resonant receiver directly above the wireless magnetic resonant transmitter of the docking station.

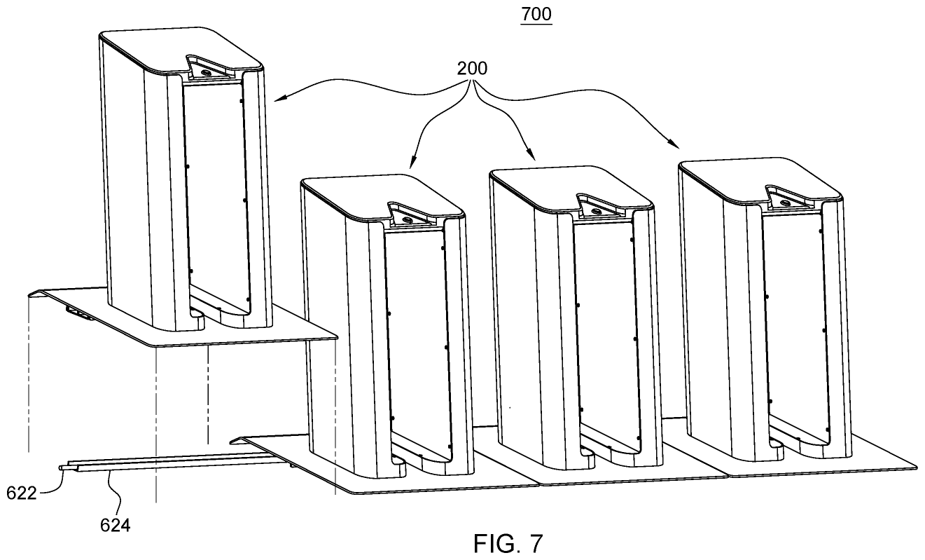

FIG. 7 illustrates one embodiment of a docking station subsystem 700 which includes multiple docking stations 200. Note that the number of docking stations in docking station subsystem 700 can vary, as desired for a particular application. As noted, in one or more embodiments, extending below the angled base plates are one or more channels 624, such as one or more metal channels, sized to accommodate cables 622, including one or more electrical cables and/or other cables, such as one or more ethernet cables.

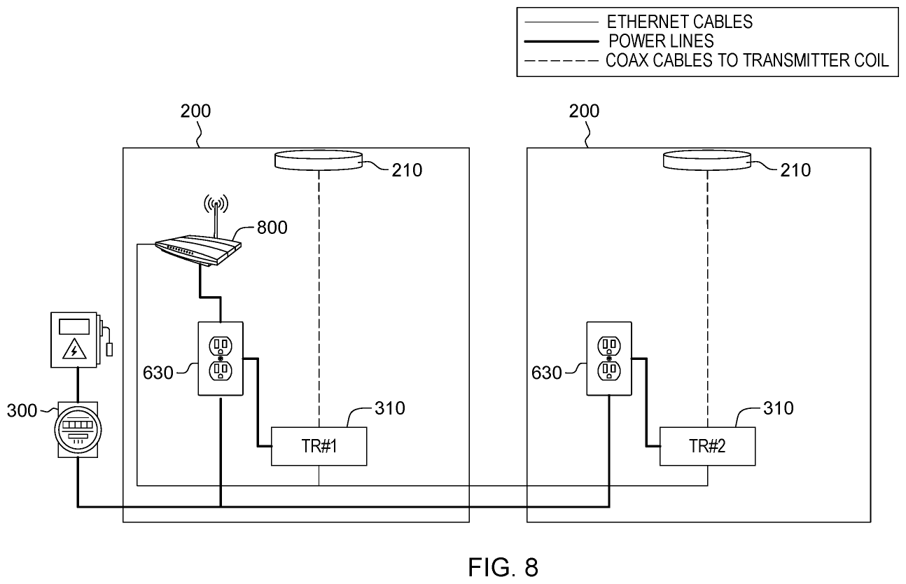

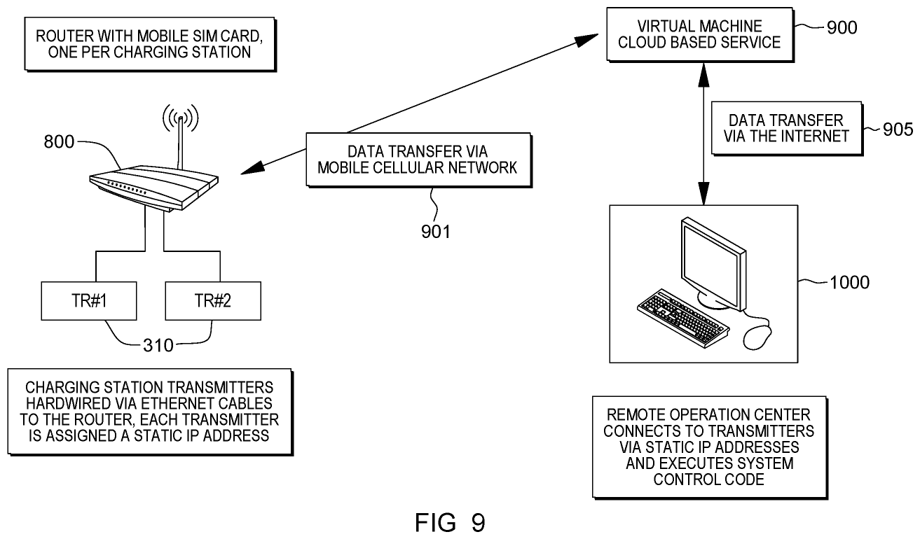

For instance, as illustrated in the schematic of FIG. 8, a docking station subsystem can include, one or more docking stations 200, and can be equipped with a router 800 connected via a cellular network to a remote system control, such as illustrated in FIG. 9. As illustrated in FIG. 8, router 800 can be electrically connected to the docking station's transmitter electronics 310 via respective ethernet cables. In one or more embodiments, each transmitter of a docking station subsystem can be remotely connected to the remote controller or remote operation center via a “wireguard” tunnel. Every onboard DC charger mounted on a vehicle that is parked at a docking station is remotely connected to the controller, or remote operation center, via the transmitter device it is communicating with. Further, as illustrated in the schematic of FIG. 8, the docking stations can be powered via, for instance, an AC meter service connection 300 through respective junction boxes or GFCI outlets 630 in the docking stations (in one embodiment).

In one or more implementations, data communication between the transmitter devices and the receiver devices is bi-directional, and provides gate keeping and/or transaction authorization, as well as facilitating monitoring and control of the physical parameters of the power supplied to the vehicle's batteries. For instance, the power transfer can be allowed after the system checks in a database that the particular vehicle identification is recognized, and its owner has an agreement with the power supplier. Monitoring control of physical parameters can include actual battery voltage, whether the target voltage is at 100 percent state of charge (SOC), battery charging current, etc. In one or more embodiments, a variety of types of batteries can be charged, such as batteries between 24V and 58.5V, in one embodiment. Further, in one or more implementations, program code can be remotely updated for the transmitter devices and receiver devices, as necessary from the remote operation center or controller.

FIG. 9 illustrates one embodiment of a computing environment for an electric micromobility vehicle charging system such as disclosed herein. As illustrated, a charging station subsystem, such as illustrated in FIG. 8, has by way of example two transmitter electronic boxes 310 of respective wireless power transmitter devices of the docking stations that are in communication via a common router 800 of the docking station subsystem. For instance, in one or more embodiments, the charging station transmitter electronics can be hardwired via ethernet cables to the router, with each transmitter being assigned a static IP address for identification by the remote operation center. Router 800 can include, for instance, a mobile SIM card, and one or more routers can be provided per docking station subsystem. Data is transferred, in one or more embodiments, via a mobile cellular network 901 to, for instance, a virtual machine cloud-based service 900 running on one or more servers. A remote operation center or remote control can be executing on one or more computer systems 1000 at, or connected to, the virtual machine cloud-based service 900 such as via, for instance, the internet 905. In this manner, the remote controller or remote operation center connects to the transmitter devices via the respective static IP addresses, and executes system control code to oversee the electric micromobility vehicle charging systems and the recording of the charging session data. For instance, in one or more embodiments, the remote operation center includes software that manages all the deployed assets, and maintains a record of physical details of every charging session for each vehicle registered in the system. This charging session data can then be used to charge the owners of the vehicle for energy delivered via the charging stations.

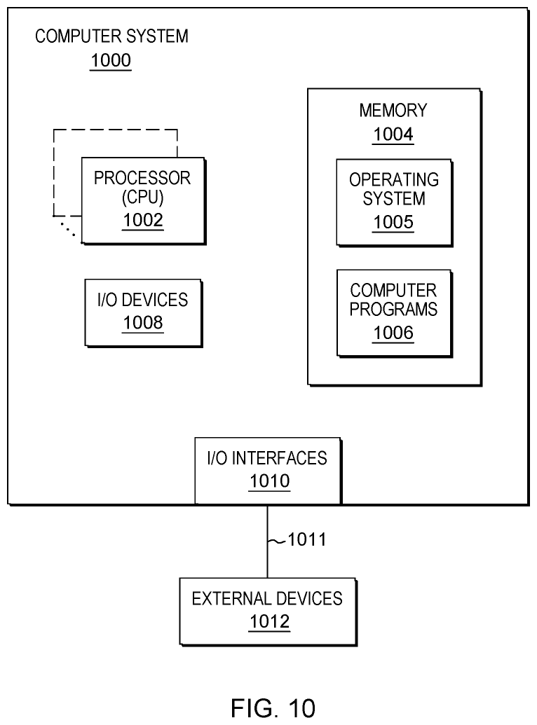

By way of further example, FIG. 10 depicts a computer system 1000 in communication with external device(s) 1012, which can be used to implement one or more control aspects disclosed herein. Computer system 1000 includes one or more processor(s) 1002, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 1002 can also include one or more registers to be used by one or more of the functional components. Computer system 1000 also includes a memory 1004, input/output (I/O) devices 1008, and I/O interfaces 1010, which may be coupled to processor(s) 1002 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and Peripheral Component Interconnect (PCI).

Memory 1004 can be, or include, main or system memory (e.g. Random Access Memory) used in the execution of program instructions, a storage device(s) such as hard drive(s), flash media, or optical media as examples, and/or cache memory, as examples. Memory 1004 can include, for instance, a cache, such as a shared cache, which may be coupled to local caches (examples include L1 cache, L2 cache, etc.) of processor(s) 1002. Additionally, memory 1004 can be, or include, at least one computer program product having a set (e.g., at least one) of program modules, instructions, code or the like that is/are configured to carry out control functions of embodiments described herein when executed by one or more processors.

Memory 1004 can store an operating system 1005 and other computer programs 2006, such as one or more computer programs/applications that execute to perform aspects described herein. Specifically, programs/applications can include computer readable program instructions that can be configured to carry out functions of embodiments of control aspects described herein.

Examples of I/O devices 1008 include but are not limited to microphones, speakers, Global Positioning System (GPS) devices, cameras, lights, accelerometers, gyroscopes, magnetometers, sensor devices configured to sense proximity. An I/O device can be incorporated into the computer system as shown, though in some embodiments an I/O device can be regarded as an external device (1012) coupled to the computer system through one or more I/O interfaces 1010.

Computer system 1000 can communicate with one or more external devices 1012 via one or more I/O interfaces 1010. Example external devices include a keyboard, a display, one or more data sensors, one or more docking stations or docking station subsystems, and/or any other devices that (for instance) enable a user to interact with computer system 1000. Other example external devices include any device that enables computer system 1000 to communicate with one or more other computing systems or peripheral devices. A network interface/adapter is an example I/O interface that enables computer system 1000 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems. (BLUETOOTH® is a registered trademark of Bluetooth SIG, Inc., Kirkland, Washington, U.S.A.)

Communication between I/O interfaces 1010 and external devices 1012 can occur across wired and/or wireless communications link(s) 1011, such as Ethernet-based wired or wireless connections. Example wireless connections include cellular, Wi-Fi, Bluetooth®, proximity-based, near-field, or other types of wireless connections. More generally, communications link(s) 1011 can be any appropriate wireless and/or wired communication link(s) for communicating data between systems and/or devices to facilitate one or more aspects disclosed herein.

A particular external device(s) 1012 can include one or more data storage devices, which can store one or more programs, one or more computer readable program instructions, and/or data, etc. Computer system 1000 can include and/or be coupled to and in communication with (e.g. as an external device of the computer system) removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk, and/or an optical disk drive for reading from or writing to a removable, non-volatile optical disk, such as a CD-ROM, DVD-ROM or other optical media.

Computer system 1000 can be operational with numerous other general purpose or special purpose computing system environments or configurations. Computer system 1000 can take any of various forms, well-known examples of which include, but are not limited to, personal computer (PC) system(s), server computer system(s), thin client(s), thick client(s), workstation(s), laptop(s), handheld device(s), mobile device(s)/computer(s), such as smartphone(s), tablet(s), and wearable device(s), multiprocessor system(s), microprocessor-based system(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

As will be appreciated by one skilled in the art, control aspects of the present invention may be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, control aspects of the present invention may take the form of a computer program product embodied in one or more computer readable medium(s) having computer readable program code embodied thereon.

Any combination of one or more computer readable medium(s) can be utilized. The computer readable medium may be a computer readable signal medium or a computer readable storage medium. A computer readable signal medium may be any non-transitory computer readable medium that is not a computer readable storage medium and that can communicate, propagate, or transport a program for use by or in connection with an instruction execution system, apparatus or device.

A computer readable storage medium can be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain or store a program for use by or in connection with an instruction execution system, apparatus, or device.

In one example, a computer program product includes, for instance, one or more computer readable storage media to store computer readable program code means or logic thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out control and/or calibration operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, on the user's personal device (e.g., phone, tablet, wearable), as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to block diagrams of methods, apparatus (systems) and computer program products according to embodiments of the invention. It will be understood that the control block of the diagram can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus (e.g., mobile device/phone), or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The block diagram in the figure illustrates the architecture, functionality, and operation of possible implementations of systems, methods and computer program products according to various embodiments of the present invention. In this regard, one or more blocks in the diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that one or more blocks of the diagram can be implemented by special purpose hardware-based systems that perform the specified functions or acts, or combinations of special purpose hardware and computer instructions.

In addition to the above, one or more aspects of the present invention can be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider can receive payment from the sale of advertising content to one or more third parties.

In one aspect of the present invention, an application can be deployed for performing one or more aspects of the present invention. As one example, the deploying of an application comprises providing computer infrastructure (including, e.g., internet/cloud/IoT resources and/or a mobile device) operable to perform one or more aspects of the present invention.

As a further aspect of the present invention, a computing infrastructure can be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system can be provided. The computer system comprises a computer readable medium, in which the computer medium comprises one or more aspects of the present invention. The code in combination with the computer system is capable of performing one or more aspects of the present invention.

Although various embodiments are described above, these are only examples. For example, computing environments of other architectures can incorporate and use one or more aspects of the present invention. Additionally, the network of nodes can include additional nodes, and the nodes can be the same or different from those described herein. Also, many types of communications interfaces may be used.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, mobile device/phone, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of the invention and the practical application, and to enable others of ordinary skill in the art to understand the invention through various embodiments and the various modifications thereto which are dependent on the particular use contemplated.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. An electric micromobility vehicle charging system comprising:
a docking station configured to facilitate docking of an electric micromobility vehicle with the docking station for charging;
a wireless power receiver device associated with the electric micromobility vehicle, the wireless power receiver device comprising a wireless magnetic resonant receiver; and
a wireless power transmitter device associated with the docking station, the wireless power transmitter device comprising a wireless magnetic resonant transmitter, wherein the docking station is configured to facilitate operative positioning, at least in part, of the wireless magnetic resonant receiver relative to the wireless magnetic resonant transmitter with docking of the electric micromobility vehicle with the docking station for charging.

2. The electric micromobility vehicle charging system of claim 1, wherein the wireless magnetic resonant transmitter comprises a transmitter coil and the wireless magnetic resonant receiver comprises a receiver coil and wherein the docking station is configured to facilitate operative positioning of the receiver coil relative to the transmitter coil with docking of the electric micromobility vehicle with the docking station for charging.

3. The electric micromobility vehicle charging system of claim 2, wherein with operative positioning of the receiver coil relative to the transmitter coil, the receiver coil and transmitter coil are substantially parallel.

4. The electric micromobility vehicle charging system of claim 2, wherein the transmitter coil is located in an upper portion of the docking station, and wherein the docking station further comprises a cover over the transmitter coil in the upper portion of the docking station.

5. The electric micromobility vehicle charging system of claim 4, wherein the cover includes an alignment feature to facilitate guiding, at least in part, the receiver coil into charging position relative to the transmitter coil with docking of the electric micromobility vehicle with the docking station for charging.

6. The electric micromobility vehicle charging system of claim 5, wherein the alignment feature of the cover is configured to be engaged by another alignment feature of a receiver coil housing containing the receiver coil to facilitate operative positioning of the receiver coil relative to the transmitter coil with docking of the electric micromobility vehicle with the docking station for charging.

7. The electric micromobility vehicle charging system of claim 6, wherein the alignment feature of the cover comprises a triangular-shaped receiving channel formed in the cover and the other alignment feature comprises a triangular-shaped alignment element sized and configured to reside within the triangular-shaped receiving channel in the cover of the docking station with docking of the electric micromobility vehicle with the docking station for charging.

8. The electric micromobility vehicle charging system of claim 6, wherein the cover further includes an interlock element associated with the alignment feature, the interlock element being configured to engage with another interlock element associated with the other alignment feature of the receiver coil housing with docking of the electric micromobility vehicle with the docking station for charging.

9. The electric micromobility vehicle charging system of claim 7, wherein the alignment feature comprises a receiving channel formed in the cover and the interlock element comprises at least one knob within the receiving channel formed in the cover of the docking station.

10. The electric micromobility vehicle charging system of claim 1, wherein the docking station comprises a wheel guide configured to receive a wheel of the electric micromobility vehicle with docking of the electric micromobility vehicle with the docking station for charging and a vertically extending housing angled in a direction of docking of the electric micromobility vehicle within the docking station.

11. An electric micromobility vehicle charging system comprising:
a universal docking station with a wheel guide configured to receive a wheel of an electric micromobility vehicle to facilitate docking of the electric micromobility vehicle with the universal docking station for charging, the electric micromobility vehicle being one electric micromobility vehicle type of multiple electric micromobility vehicle types dockable for charging within the universal docking station;
a wireless power receiver device associated with the electric micromobility vehicle, the wireless power receiver device comprising a wireless magnetic resonant receiver; and
a wireless power transmitter device associated with the docking station, the wireless power transmitter device comprising a wireless magnetic resonant transmitter, wherein the docking station is configured to facilitate operative positioning, at least in part, of the wireless magnetic resonant receiver associated with the electric micromobility vehicle relative to the wireless magnetic resonant transmitter associated with the docking station with docking of the electric micromobility vehicle within the universal docking station for charging.

12. The electric micromobility vehicle charging system of claim 11, wherein the multiple electric micromobility vehicle types are selected from the group consisting of electric bike types and electric scooter types.

13. The electric micromobility vehicle charging system of claim 11, wherein at least two electric micromobility vehicle types of the multiple electric micromobility vehicle types have different battery types associated therewith to respectively power the at least two electric micromobility vehicle types.

14. The electric micromobility vehicle charging system of claim 11, wherein the wireless magnetic resonant transmitter comprises a transmitter coil and the wireless magnetic resonant receiver comprises a receiver coil, and wherein the universal docking station is configured to facilitate operative positioning of the receiver coil relative to the transmitter coil with operative docking of the electric micromobility vehicle with the universal docking station for charging.

15. The electric micromobility vehicle charging system of claim 14, wherein the transmitter coil is located in an upper portion of the universal docking station, and the electric micromobility vehicle charging system further comprises:
a cover over the transmitter coil in the upper portion of the universal docking station, wherein the cover includes an alignment feature to facilitate guiding, at least in part, the receiver coil into a charging position relative to the transmitter coil with docking of the electric micromobility vehicle within the universal docking station for charging.

16. The electric micromobility vehicle charging system of claim 15, wherein the alignment feature of the cover is configured to be engaged by another alignment feature of a receiver coil housing containing the receiver coil to facilitate operative positioning of the receiver coil relative to the transmitter coil with docking of the electric micromobility vehicle with the universal docking station for charging.

17. The electric micromobility vehicle charging system of claim 16, wherein the cover further includes an interlock element associated with the alignment feature, the interlock element being configured to engage with another interlock element associated with the other alignment feature of the receiver coil housing with docking of the electric micromobility vehicle with the universal docking station for charging.

18. An electric micromobility vehicle docking station comprising:
a housing with a wheel-receiving opening within the housing, the wheel-receiving opening being sized to receive a wheel of an electric micromobility vehicle when the electric micromobility vehicle is docked with the electric micromobility vehicle docking station for charging; and
a wireless power transmitter device disposed, at least in part, within the housing over the wheel-receiving opening of the housing, the wireless power transmitter device facilitating wireless power transfer to a wireless power receiver device associated with the electric micromobility vehicle when the electric micromobility vehicle is operatively docked with the electric micromobility vehicle docking station for charging.

19. The electric micromobility vehicle docking station of claim 18, wherein the wireless power transmitter device comprises a wireless magnetic resonant transmitter, and the wireless power receiver device comprises a wireless magnetic resonant receiver, and wherein the wireless magnetic resonant transmitter is positioned within the housing over the wheel receiving opening of the housing.

20. The electric micromobility vehicle docking station of claim 18, wherein the wheel-receiving opening extends through the housing.
